(19) United States
(12) Patent Application Publication
(10) Pub. No.: US 2009/0024743 A1
(43) Pub. Date: Jan. 22, 2009

(54) MEDIA SESSION DATA TRANSMISSION CONTROL METHOD, CONTROL RELATION NEGOTIATION METHOD AND CONTROL DEVICE AND SYSTEM

(75) Inventors: Liming Zhang, Shenzhen (CN); Lei Zhu, Shenzhen (CN); Long Luo, Shenzhen (CN); Qiongyan Liu, Shenzhen (CN); Aiqin Zhang, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/237,548

(22) Filed: Sep. 25, 2008

Related U.S. Application Data
(63) Continuation of application No. PCT/CN2007/000147, filed on Jan. 15, 2007.

(30) Foreign Application Priority Data
Mar. 28, 2006 (CN) 200610034792.X

(51) Int. Cl. G06F 15/173

(52) U.S. Cl. 709/226; 709/223

(57) ABSTRACT

A media session data transmission control method, a control relation negotiation method and a control device and a system thereof. The data transmission control method includes: the server obtains the media transmission right request of the sender (S601); the server distributes the first media transmission right for the sender based on the first media control strategy (S602); the control relation negotiation method includes: the server receives the media negotiation request from the caller, the media information to be negotiated is carried in the media negotiation request; the server establishes the corresponding media control relation for the caller based on the second media control strategy. Through the application of the media control strategy, the invention optimizes the existing media control process, provides more reasonable and efficient media control, the invention can be applied to multimedia and multiple party communication, and multimedia cluster communication widely.

This application is a Continuation application of PCT International Application No. PCT/CN2007/000147, filed on Jan. 15, 2007, claiming priority to the Chinese Patent Application No. 200610034792.X, filed with the Chinese Patent Office on Mar. 28, 2006, entitled “Media Session Data Transmission Control Method, Control Relationship Negotiation Method and Control System”, contents of both foregoing applications are incorporated herein by reference in their entirety.

### FIELD OF THE INVENTION

The present invention relates to the field of communication technologies, and in particular to a negotiation method for a media data transmission control method and control relationship in a session, and to a control device and system.

### BACKGROUND OF THE INVENTION

With the development of broadband networks, mobile communications are not limited to traditional speech communications only and multimedia services incorporating various types of media such as audios, videos, pictures and texts are being provided gradually. Through the combination of the multimedia services and data services such as presence services, short messages, Web browsing, location information, PUSH services and file sharing, various demands of users can be satisfied. For instance, message services include instant messages, chat room messaging, and multimedia messages; video services provide entertainment, multimedia information, and daily communications; electronic commerce includes product catalogs, search engines, shopping carts, order management, and payment; games include individual games, and group games; location services include people search, guider services, and police-calling; and personal assistants service includes address storage, calendar services, bookmark management services, file storage, event reminding, and email services.

Driven by various applications, an IP based Multimedia Subsystem (IMS) in the prior art implements multifarious multimedia applications in a communication network by use of a standardized open architecture, offering users more options and more colorful experiences.

A multi-party communication becomes an increasingly popular service. In order to implement such a multi-party communication, a centralized control point is necessarily required for consistent and real time management. For example, if a user in a system requests audio transmission, one and only one control point in the system is needed to make a determination. Such a system may be a Push to talk over Cellular (PoC) system, a conference system, etc. The PoC system is a centrally controlled multi-party multimedia communication system.

The concept of PoC service originates from an interphone, and its user experiences the same use as that of the interphone—a simple and convenient half-duplex communication. A talk group is predetermined by the user, and the user presses a specific key for a talk without dialing, so that his speech can be conveyed concurrently to all other members in the group, that is, push to talk, and a call connection and setup is completed instantaneously. The talk is carried out in a half-duplex way, and when one party speaks, the other members can only listen but not speak.

An essential design idea of the PoC service is to provide packet voice services by the use of an existing GSM/GPRS network. The half duplex mode similar to that for an existing group talk is adopted for the logic of the PoC service, and one-to-one and one-to-many communications are supported. In the implementation of the system, an operator is required to introduce a new network element at a network side, which is responsible for service registration, authentication and communication processing of PoC users, and this new network element is a usually called service gateway connected with a GPRS Gi interface. Also, a mobile phone terminal is required to be integrated with PoC capabilities, and thus the terminal can set up a packet speech process through a SIP after a Packet Data Protocol (PDP) Context is activated. Once a connection is set up, it is always on line, and a talk can be carried out at any time.

Firstly, speech information is converted into a data stream, which is then packed into data packets and transmitted to a PoC server of a network operator via a wireless interface. The destination of the data packets is obtained through IP protocol, and the data packets are transmitted to the destination. A speech communication service is based upon a client-server architecture. A PoC client of the mobile terminal uses services provided by a PoC server in a network. The PoC server transmits received data to one or more receivers, and the data is received with a delay of only a few seconds. A message can be transmitted to a plurality of receiving parties at a time. In order to control a correct communication, the PoC server may control a signaling flow and it is ensured that only one user transmits data or uses a speech channel at a time. The PoC server may also perform a control so that a talk is carried out in a prescribed talk group.

PoC standards specification is defined by the Open Mobile Alliance (OMA), and a schematic diagram of a PoC network defined in this specification is shown in FIG. 1. The PoC network is based upon an IMS (“SIP/IP core” as illustrated in the Figure) and mainly includes the following entities:

PoC Server, which is a primary call control device for services, and is an application server in the IMS network.

PoC XDMS, which is a server used for storing data such as group information and the like required by the PoC service.

PoC Client, which is used by a user to initiate/receive a PoC talk to/from the PoC server, to request a floor, or to make a speech, etc.

After a PoC Group Talk is set up, a user can request the PoC server for a floor through the TBCP/MBCP protocol. Only if the user is offered a floor, he is allowed to speak, and a Talk Burst/Media Burst generated from his speech can be transmitted by the PoC server to other members in the group.

FIG. 2 illustrates a schematic diagram of a flow of requesting for a floor, primarily including:

Steps 1-2: A user can request the PoC server for a right of speech or media transmission through a Talk/Media Burst Request message of the TBCP/MBCP protocol.

Steps 3-4: The PoC server returns to the requester a Talk/Media Burst Granted message informing that he has already been granted a right of speech or media transmission.

Steps 5-6: The PoC server also sends a Talk/Media Burst Taken message to other participants in order to transmit the information about the current speaker or media stream transmitter to them.

Steps 7-10: The user who is given a floor speaks, and his Talk Burst or Media Burst is transmitted to the other members in the group through the PoC server.

Steps 11-12: The user finishes the speech or media stream transmission and releases the floor.

Steps 13-16: The media floor for a corresponding type of media (Talk Burst or Media Burst) is idle, and the PoC server broadcasts a Floor Control Idle message to the members of the group.

The existing PoC system can support the capability of Talk Burst Request Queue. In other words, when a plurality of users concurrently initiate requests for a floor, the PoC server, which is responsible for arbitration, grants the floor to only one of the plurality of users and refuse floor requests of the other members or place the floor requests of the other members into a Talk Burst Request Queue. When a current speaker releases the floor, the PoC server selects a requester from the queue according to a certain policy, and grants the floor to the requester.

A more advanced version PoC2.0 of the PoC service, which is defined by the Open Mobile Alliance (OMA), allows a user to set up a multimedia session through a specific key to communicate with other one or more users instantly, and to transmit various types of media during the session, such as a still picture, a real time video stream, a file and texts. The PoC2.0 is backwards compatible with the PoC1.0 and also supports half duplex speech service in the PoC1.0.

Because the PoC2.0 allows concurrent transmission of various types of media in the same one session, floors for multiple types of media in the session need to be controlled, and the controls on the floors for each type of media are independent of and irrelevant to each other.

As illustrated in FIG. 3, a POC client A/B is a PoC2.0 terminal which supports speech, video, and a combination media of speech and video, simply referred to as video&audio here. A PoC client C is a PoC1.0 terminal which supports only speech. In the prior art, a PoC server performs a media transmission control on the speech and the video&audio in a session respectively through two different state machine entities: a client and a PoC server control video & audio media through their respective video&audio control entities, and control speech transmission through respective speech control entities, and the controls on floors for the two types of media are totally independent of each other. For example, when the PoC client A is to transmit video & audio, it is necessary for the client A to request the PoC server for a video & audio floor. If the video&audio floor is idle at present, the PoC server grants the video&audio floor to the user. After acquisition of the video & audio floor, the user can transmit a certain video & audio, for example, play a video file or output real time video & audio (transmitting video through a camera while speaking). The PoC sever receives the media and transmits the video & audio to other users. In the above example, the PoC server transmits the media only to the PoC client B but not to the PoC client C since the PoC client C does not support video&audio. Likewise, if the PoC client A wants to speak, he is required to request a speech floor, and other processes are similar to those for video&audio.

In the prior art, a client may request a plurality of media floors. For example, the PoC client A may request a speech floor during transmission of video&audio. In a specific scenario where the PoC client A explains a video&audio clip to other users and at the same time transmits the video&audio clip to them, floors for two types of media are required.

Further, before requesting a floor for a certain type of media, a user is required to negotiate with a PoC server about a corresponding media control relationship. In the above example, for instance, the PoC client A is required to firstly negotiate with the PoC server about relationship between Media Types (e.g. video and audio) and Floor Control Entities before requesting a video&audio floor (as is depicted with a red line between the client A and the server in FIG. 3), and after the negotiation, two transmission and reception ports for audio and video of the client A (e.g. a first port for transmission and reception of audio, and a second port for transmission and reception of video) and transmission and reception ports for the server end (e.g. a third port for transmission and reception of audio, and a fourth port for transmission and reception of video) are determined, and control ports for the media are also determined (e.g. a fifth port for the client, and a sixth port for the server end). Likewise, a similar relationship is also established between the client B and the PoC server.

Poor user experiences may be brought about under some conditions in the prior art.

In an example, if there is a video&audio session while a speech session is ongoing, a terminal may acquire two floors and transmit two types of voice-carrying media streams concurrently. At this time, the floors for different media are independent of each other, and controls on the two voices are independent of each other, so that concurrent transmission of voices from the terminal may result in confusion of expressions in the PoC session and poor user experience.

In another example, while a PoC user A is in an ongoing speech session, if another PoC user B acquires a floor for video&audio session, when both terminals transmits speech concurrently, other users in the session may hear voice-carrying media streams from the two users at the same time, with an experience similar to that in a full duplex, the feature of which is not consistent with that of the PoC.

In the prior art, a user is allowed to negotiate about any number of media control relationships, which is not feasible in a practical service procedure. As such, the number of media control relationships greatly increases difficulties in controlling a server, and further it results in complexity in the use of the user. Consequently, the number of media control entities that can be successfully negotiated in a session and the types of media that can be successfully negotiated in the session to be bound with the media control entities should be limited according to a certain policy and practical service demands.

When there are multiple media control relationships, media in the multiple media control relationships are actually associated with one another (for example, when a user obtains a speech floor and then obtains a video&audio floor, it is enough for a client to transmit video&audio only, and the PoC server is required to extract audio from video&audio and transmit the audio to a POC1 user. At this time, the PoC server should prevent another user from obtaining a speech floor). Therefore, it is necessary for the PoC server to maintain and determine the related information.

### SUMMARY OF THE INVENTION

The present invention provides a media session data transmission control method, control relationship negotiation method and control device and system.

An embodiment of the invention provides a media session data transmission control method. The method includes:
receiving, by a server, a media floor request from a transmitting end; and
allocating, by the server, a first media floor to the transmitting end according to a first media control policy.

An embodiment of the invention provides a media session control relationship negotiation method including:
receiving, by a server, from a calling end a media negotiation request carrying information on media to be negotiated about;
establishing, by the server, a corresponding control relationship for the calling end according to a second media control policy.

An embodiment of the invention further provides a media session control server. The Server includes:
a media policy control element, adapted to determine a control policy of a media communication for a calling end and a called end according to a predefined control policy;
a media control entity, adapted to receive the control policy transmitted from the media policy control element and to control the media communication between the calling end and the called end.

An embodiment of the invention provides a media session control system, comprising a calling end, a called end, and the above server, the server controlling a media communication between the calling end and the called end according to a predefined policy.

In the solutions provided according to the embodiments of the invention, with the use of the media control policies, the first media floor is allocated to the transmitting end and the corresponding media control relationship is established for the calling end according to the media control policies, so as to optimize existing media control procedures and provide a more reasonable and efficient media control method, which can be applied widely in systems of a multimedia multi-party communication, a multimedia group communication and the like.

### BRIEF DESCRIPTIONS OF THE DRAWINGS

FIG. 1 is a schematic diagram of a network architecture as defined in the OMA PoC Specification in the prior art;

FIG. 2 is a schematic diagram of an OMA PoC flow of requesting a floor in the prior art;

FIG. 3 is a schematic diagram of a multimedia control method in the prior art;

FIG. 4 is a schematic diagram of a structure of a multimedia session control system according to an embodiment of the invention;

FIG. 5 is a schematic diagram of a specific structure of a media policy control element according to an embodiment of the invention;

FIG. 6 is a schematic diagram of a media floor management method according to an embodiment of the invention;

FIG. 7 is a schematic diagram of a flow in which a PoC server allocates a first media floor to a transmitting end according to a first media control policy according to an embodiment of the invention;

FIG. 8 is a schematic diagram of a flow in which a transmitting end negotiates with a PoC server about a media control relationship according to an embodiment of the invention;

FIG. 9 is a schematic diagram of a flow in which a PoC server establishes a corresponding media control relationship for a calling end according to a second media control policy according to an embodiment of the invention;

FIG. 10 is a schematic diagram of a flow in which a PoC server negotiates with a called end about a media control relationship according to an embodiment of the invention;

FIG. 11 is a schematic diagram of a flow in which a client requests for a media floor; according to an embodiment of the invention;

FIG. 12 is a schematic diagram of a flow in which a client negotiates with a PoC server about a media control relationship according to an embodiment of the invention.

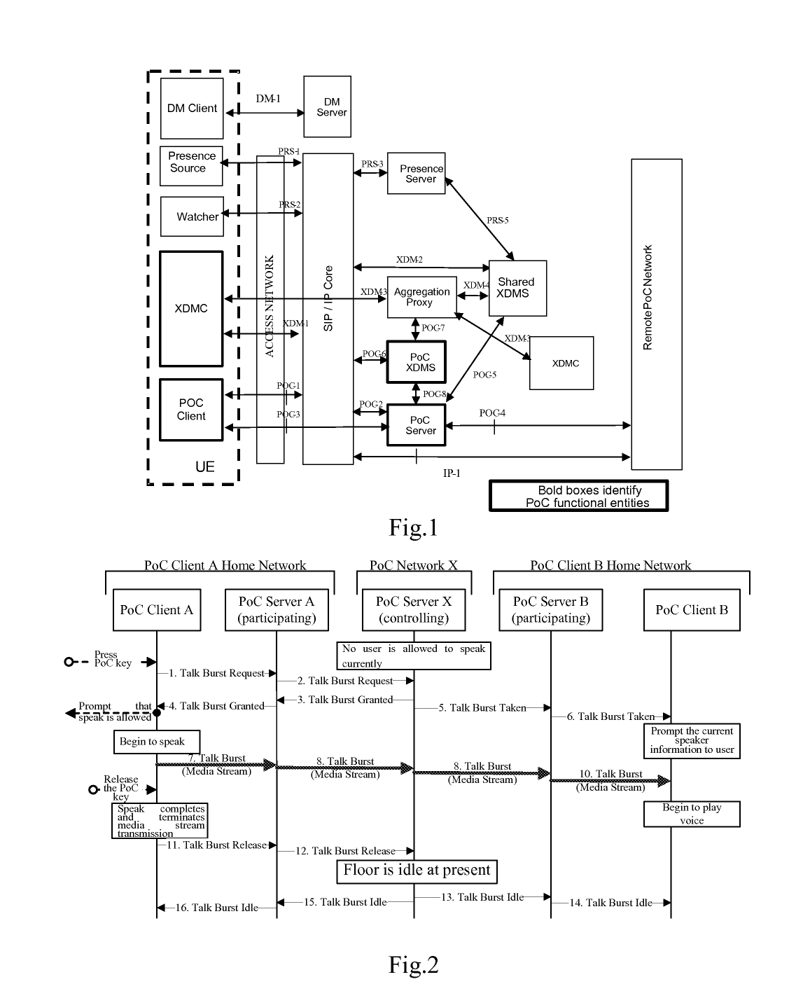

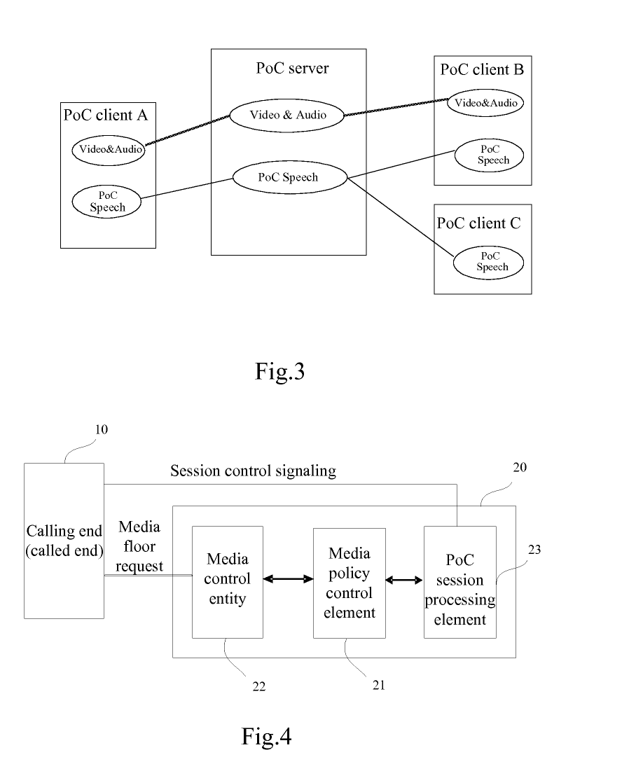

### DETAILED DESCRIPTIONS OF THE EMBODIMENTS

Embodiments of the invention will be described hereinafter with reference to the drawings of the description.

In the embodiments of the invention, a server in a multimedia session control system can support a multi-part multimedia communication service, e.g. a PoC service, a conference service, a multimedia conference service and other group services and etc. For convenience, a PoC service communication will be used as an example in the following description of the embodiments.

FIG. 4 and FIG. 5 illustrate schematic diagrams of a structure of a media session control system according to an embodiment of the invention. As can been seen from the figures, this system includes a calling end (called end) 10 and a PoC server 20 which controls the calling end (called end) 10 to perform a multimedia communication. The PoC server 20 includes:

A media control entity 22, which includes a video&audio control entity 221 adapted to control a video&audio communication between the calling end and the called end, and/or

a speech control entity 222 adapted to control a speech communication between the calling end and the called end.

The client and the PoC server exchange media control signaling and specific media information, for example, applying for media transmission request right, and assigning media transmission request right.

Upon receipt of a media transmission permission, the client transmits specific media data to the PoC server, or the PoC server transmits media data to the client.

A media policy control element 21 is adapted to exchange with the media control entity 22 to determine a control policy. The media control entity 22 controls a multimedia communication between the calling end and the called end according to the determined policy.

The media policy control element 21 further includes:

a media control policy storage element 213, which is adapted to store a media control policy;

a first media control policy element 211, which stores a first media control policy and is adapted to allocate a first media floor to a transmitting end;

a second media control policy element 212, which is adapted to establish a corresponding media control relationship for the calling end.

The PoC server 20 further includes:

a PoC session processing element 23, which is adapted to exchange with the calling end and the called end to implement the multimedia communication.

The media control policy can be specified by an operator according to service demands. Specifically in the PoC system, a media control policy storage system may be an XDMS system (an XML based document management system) or an independent system other than XDMS. Further, the media control policy storage system may also be integrated with the media policy control element, both of which are co-located in the PoC server.

A media control policy maintenance terminal 214 is adapted to maintain the media control policy, through which the media control policy in the media control policy storage element is maintained by operations of addition, deletion, modification and etc, for example. Specifically in the PoC system, it can be an XDMC entity (a client of an XML based document management system) or an independent system other than XDMC. Further, the entity of media control policy maintenance terminal may be located in a PoC client.

In the embodiment of the invention, the PoC server performs signaling-layer session control of and exchange with a transmitting end (receiving end), for example, initiate/teardown a call, negotiates about a media control relationship, etc., through session control signaling.

In the PoC server, a media policy control element is added, which primarily accomplishes the following functions:

providing methods of modifying and selecting a media control policy;

controlling negotiation about a media control relationship between respective PoC clients and a server;

controlling allocation of a media floor and coordinating relationship between multiple media control relationships according to a policy.

The media control policy can be the following contents:

1. Types of media control relationships allowed to be established in a media session. According to this policy, the PoC server can refuse a user for establishing a media control relationship that is not allowed in a session, thereby effectively controlling the number of media control relationships.

For example, the media control policy may be that only four types of control entities are allowed to be present in a session, speech, video&audio, and discrete media, or only speech and video are allowed to be present, etc.

The PoC server can select a corresponding policy according to a type of an initiated session. This selection policy can also be defined by an operator.

For example for a group session, four types of control entities are allowed to be present, i.e. speech, video, video&audio, and discrete media, and for a point-to-point session, only two control entities, i.e. speech and video, are allowed to be present. Also a speech control entity can be specified as a control entity that is necessarily negotiated about.

2. Descriptions of associations between media control relationships and mutual include relationships therebetween. For example, a media control relationship A includes a media control relationship B.

3. A policy of granting a media floor in a session.

For example, media floors that have inclusion relationship with each other are not granted concurrently. For example, the media control relationship A includes the media control relationship B, and when the PoC server grants a media floor to a user A, the relationship B is also set in a preemption status, and thus a conflict between two media can be avoided. Specifically, for example, it is prescribed that the video&audio control entity be related with the speech control entity, and when a user is granted for a video&audio floor, the speech control entity is set to be in a preemption state, and therefore concurrent voice transmission from two users can be avoided.

4. Descriptions of whether related media are copied to an associated media control entity and are transmitted. For example, the PoC server grants a video&audio floor to the client A, and an associated media control relationship relates to the speech control entity and the video control entity. A policy of the PoC server can define whether to copy media to the speech and video control entities when the client A transmits video & audio and to distribute the media to other clients, and can define what requirements a client to whom the distribution is directed should meet.

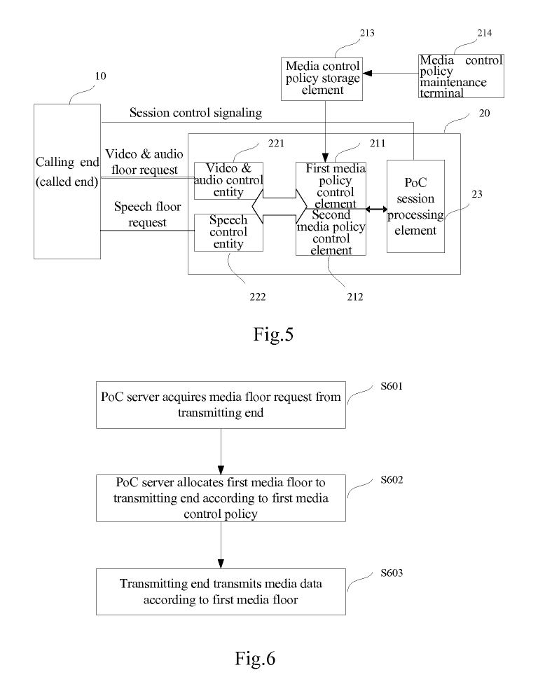

FIG. 6 illustrates a flow of a media floor management method according to an embodiment of the invention, which includes the following steps:

S601: A PoC server acquires a media floor request from a transmitting end.

The media floor request is transmitted from a transmitting end or a media request queue.

S602: The PoC server allocates a first media floor to the transmitting end according to a first media control policy.

In this step, the first media floor is allocated to the transmitting end according to the first media control policy. Here, the first media control policy may be that

the requested media floor has no association relationship with a media floor currently granted by the system, and this association relationship refers to that

the requested media floor and the media floor currently granted by the system have an include relationship; or that

the requested media floor and the media floor currently granted by the system have a cross relationship; or that

part of the requested media floor and the media floor currently granted by the system have a mutual include relationship.

For example, the media floor currently granted is “audio +video”, and the requested media floor is ‘audio+text”. Therefore, audio is included in both the media floor currently granted and the requested media floor.

S603: The transmitting end transmits media data according to the first media floor.

After the transmitting end acquires a related media floor, the PoC server processes received media according to the first media control policy, and the first media control policy may be that

when the media floor acquired by the transmitting end is one for multiple types of media, the received media are copied to an associated media control entity and transmitted. For example, the PoC server grants the client A a video&audio floor, and the associated media control entity is a speech control entity and a video control entity. According to the policy of the PoC server, when client A transmits video & audio, speech media are copied to the speech control entity and are distributed to other qualified clients, e.g. a PoC1.0 client.

If the requested media floor is associated with the media floor currently granted, the media floor request is refused.

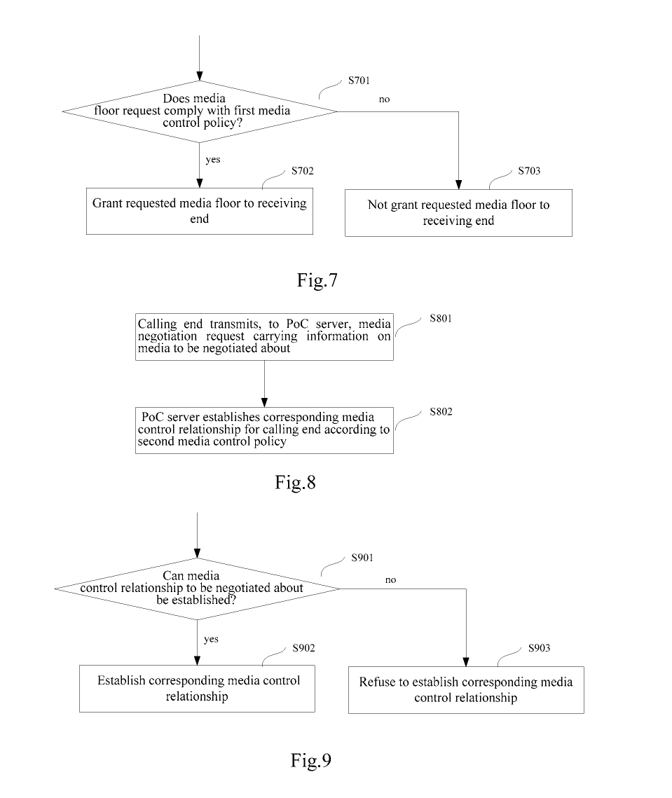

FIG. 7 illustrates a flow in which the PoC server allocates a first media floor to the transmitting end according to a first media control policy. The flow includes the following steps:

S701: The PoC server determines whether the media floor request complies with the first media control policy, and if so, the flow goes to step S702, otherwise the flow goes to step S703.

S702: The transmitting end is granted the requested media floor.

The step further includes:

after the transmitting end is granted the requested media floor, a second media floor, which has an association relationship with the media floor requested by the transmitting end, is set a preemption status, and a media floor preemption message is transmitted to a client associated with the second media floor. Thus when another client also requests the related media floor, the PoC server can directly refuse the request or place the request into a queue to avoid a conflict in the system.

In the above solution, prior to requesting the media floor, the transmitting end can also negotiate with the PoC server about a media control relationship.

FIG. 8 illustrates a flow in which the transmitting end and the PoC server negotiate about a media control relationship according to an embodiment of the invention, which particularly includes the following steps:

S801: A calling end transmits to the PoC server a media negotiation request carrying media information requested to be negotiated about.

S802: The PoC server establishes a corresponding media control relationship for the calling end according to a second media control policy.

The second media control policy may be that

a certain media control relationship is allowed to be present in a session.

FIG. 9 illustrates a flow in which the PoC server establishes a corresponding media control relationship for the calling end according to the second media control policy, which particularly includes the following steps:

S901: The PoC server determines whether the media control relationship requested to be negotiated about complies with the second media policy, and if so, the flow goes to step S902, otherwise the flow goes to step S903.

S902: The corresponding media control relationship is established.

S903: Establishment of the corresponding media control relationship is refused.

In the above step S902, the corresponding media control relationship established includes that media control relationships which can be established are restricted in advance according to the second media control policy.

In the above step S902, the media control relationship is restricted to be a type and/or a number.

In the above step S902, there may be multiple media control relationships requested to be negotiated about, and thus in the step S902, there is a possibility of establishing multiple media control relationships.

If the media control relationships requested to be negotiated about can be established in part, part of media control relationships is established in the step S902.

In the step S903, if the media control relationship requested by the transmitting end is refused, the media control policy may be returned to the calling end to inform the calling end of relevant information.

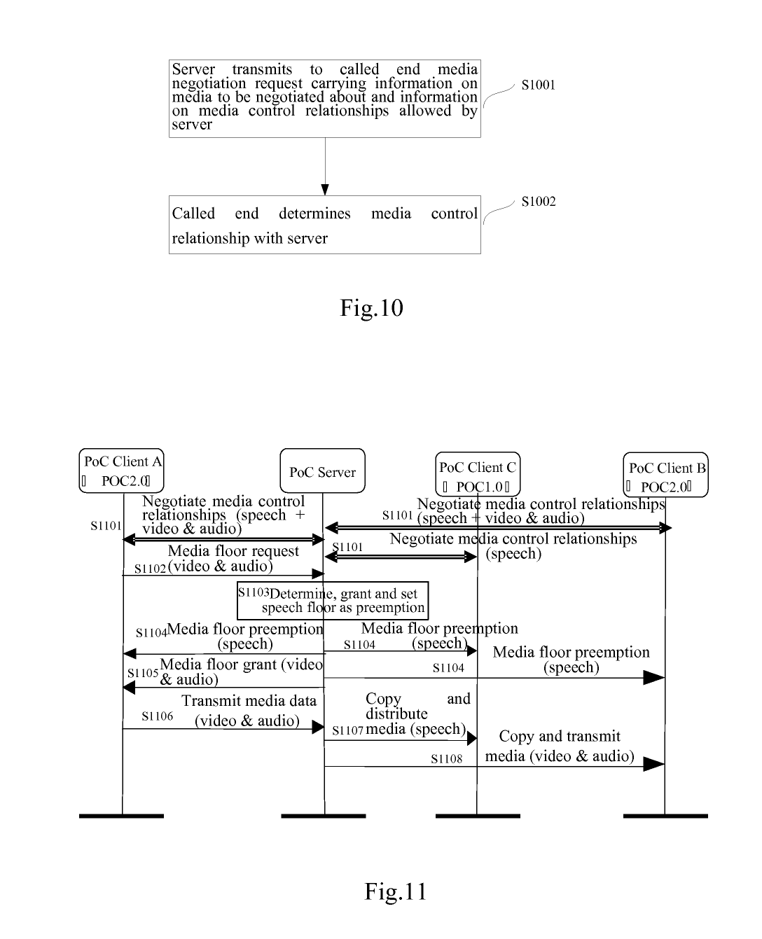

After the calling end and the PoC server have established a media control relationship, a media control relationship between a called end and the PoC server can also be established. FIG. 10 illustrates a flow in which the PoC serer and the called end negotiate about a media control relationship, which particularly includes the following steps:

S1001: The PoC server transmits to the called end a media negotiation request carrying media information to be negotiated about.

S1002: The called end determines the media control relationship with the PoC server.

In the step S1001, the media negotiation request further carries requested media control negotiation parameters. The media control negotiation parameters carry media information supported by the calling end, the PoC server and the called end.

In the step S1001, the media negotiation request further carries media control relationships allowed by the system, i.e. media control relationships for the current session, which are allowed in the second media control policy.

In the above solution, there may be multiple first media control policy and/or second media control policy, which can be selected for use according to different trigger conditions. The trigger conditions may be that

different first media control policy and second media control policy can be selected for use according to different media types, and/or

different first media control policy and second media control policy can be selected according to different callers, and/or

different first media control policy and second media control policy can be selected for use according to other policies defined by an operator.

As illustrated in FIG. 11, there are three clients: the PoC client A and the PoC client B are PoC2.0 clients supporting multimedia and the PoC client C is a PoC1.0 client only supporting speech. A procedure for requesting a media floor is as follows:

S1101: the caller and the PoC server negotiate about two pairs of media control relationships through a series of procedures: speech+video; the PoC client C and the PoC server negotiate about a pair of media control relationships through a series of procedures: speech; and the PoC client B and the PoC server negotiate about two pairs of media control relationships through a series of procedures: speech+video&audio.

S1102: The PoC client A requests for a media floor of video&audio.

S1103: The PoC server determines according to a current policy that the media floor of video&audio can be granted to the PoC client A, and also set a media floor of speech associated with video&audio as being preempted.

S1104: Since the floor of speech is set as being preempted, the speech control entity of the PoC server transmits a speech floor preemption message to the respective clients.

S1105: The PoC server grants the PoC client A the media floor of video&audio.

S1106: The PoC client A transmits media data to the PoC server.

S1107: According to a policy, the PoC server extracts speech from a video&audio control entity, copies speech to the speech control entity, and transmits the speech to the other PoC client C through the speech control entity.

S1108: The PoC server copies and transmits video&audio to the PoC client B.

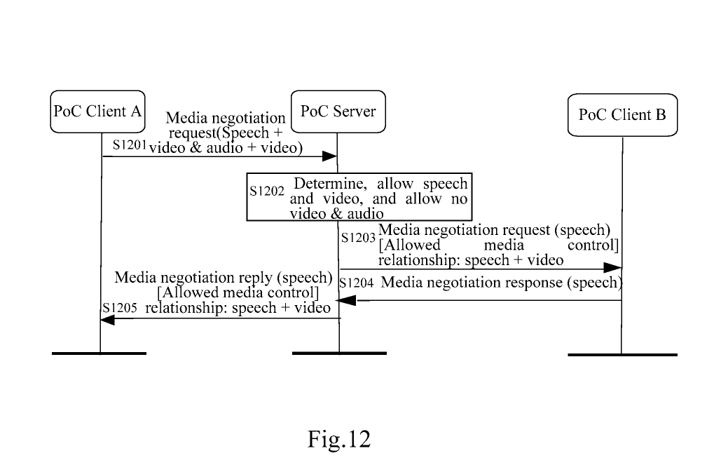

FIG. 12 illustrates a schematic diagram of negotiation between a client and a PoC server about a media control relationship. The calling end supports speech, video&audio, and video, the system supports speech and video but does not allow video&audio, and the called end supports only speech. A procedure of negotiation about a media control relationship includes:

S1201: The PoC client A transmits to the PoC server a media negotiation request carrying information on media control relationships among speech, video&audio, and video.

S1202: According to the second media control policy, the PoC server determines that the system allows a media control relationship between speech and video, but does not allow media control relationship between video and audio.

S1203: The POC server transmits to the PoC client B information carrying requested media control negotiation parameters, and the content being carried is speech.

S1204: The PoC client B returns a media negotiation response to the PoC server.

S1205: The PoC server returns a media negotiation reply to the PoC client A, informing that an allowed media control relationship is the one between speech and video.

With respect to the embodiments of the invention, the multimedia association control method has been described by taking speech and video&audio as typical examples. Similar methods can adopted for associations of types of other media.

With the use of media control policies, the present invention optimizes existing media control methods and provides a more reasonable and efficient media control method, and the present invention can be applied widely in systems of a multimedia multi-party communication, a multimedia group communication and the like.

It is evident that various modifications and equivalent substitutions made to the invention without departing the spirit and scope of the invention shall fall within the claimed scope of the invention.

What is claimed is:

1. A media session data transmission control method, comprising:
receiving, by a server, a request for a media floor from a transmitting end; and
allocating, by the server, a first media floor to the transmitting end according to a first media control policy.

2. The method according to claim 1, wherein the first media control policy is that:
the requested media floor has no association relationship with a media floor currently granted by a system, the association relationship comprising:
the requested media floor and the media floor currently granted by the system have an including and included relationship; and/or
have a cross relationship; and/or
have a mutual inclusion relationship.

3. The method according to claim 2, wherein the allocating of the first media floor to the transmitting end comprises:
determining, by the server, whether the media floor request complies with the first media control policy;
granting the transmitting end the requested media floor if the media floor request complies with the first media control policy;
otherwise, not granting the transmitting end the requested media floor, wherein when the requested media floor is not granted to the transmitting end, the server refuses to grant the requested media floor to the transmitting end or put the request for the media transmission right into a media queue.

4. The method according to claim 3, wherein the granting of the transmitting end the requested media floor further comprises:
setting a second media floor, which has an association relationship with the media floor requested by the transmitting end, in a preemption status, and transmitting a media floor preemption message to a client associated with the second media floor.

5. The method according to claim 2, comprising:
after allocating the first media floor to the transmitting end, copying, by the server, related media data to an associated media control entity and transmitting the related media data to a client.

6. The method according to claim 1, comprising:
negotiating, by a calling end and the server, about a media control relationship before the server receives the request for a media floor from the transmitting end;
receiving, by the server, a media negotiation request from the calling end, the media negotiation request carrying information on media to be negotiated about; and
establishing, by the server, a corresponding media control relationship for the calling end and defining type and/or number of the media control relationship, according to a second media control policy.

7. The method according to claim 6, wherein the establishing of the corresponding media control relationship for the calling end according to the second media control policy comprises:
determining, by the server, whether the media control relationship to be negotiated about complies with the second media control policy;
at least partly establishing the corresponding media control relationship to be negotiated about according to the information on media to be negotiated about, if the media control relationship to be negotiated about complies with the second media control policy;
otherwise, refusing to establish the corresponding media control relationship.

8. The method according to claim 7, further comprising the step of transmitting the second media control policy to the calling end, the second media control policy comprising:
allowing a certain media control relationship to be present in a session.

9. The method according to claim 6, wherein there are a plurality of the first media control policies and/or the second media control policies, which can be selected for use according to a trigger condition.

10. The method according to claim 1, further comprising:
negotiating, by the server, with a called end about a media control relationship in advance before allocating the first media floor to the transmitting end, wherein the negotiating, by the server, with the called end about the media control relationship in advance comprises:
transmitting, by the server, to the called end a media negotiation request carrying information on media to be negotiated about; and
determining the media control relationship between the server and the called end.

11. The method according to claim 10, wherein the media negotiation request further carries requested media control negotiation parameters, and the requested media control negotiation parameters carry information on media that are supported by a calling end, the server and the called end.

12. The method according to claim 10, wherein the media negotiation request further carries a media control relationship allowed by the system, the media control relationship allowed by the system being a media control relationship allowed for a current session according to the second media control policy.

13. A media session control relationship negotiation method, comprising:
receiving, by a server, a media negotiation request carrying information on media to be negotiated about from a calling end; and
establishing, by the server, a corresponding control relationship for the calling end according to a second media control policy.

14. The method according to claim 13, wherein the establishing of the corresponding media control relationship comprises restricting media control relationships which can be established between the calling end and the server according to the second media control policy.

15. The method according to claim 14, wherein the restricting comprises restricting types and/or number of media control relationships that can be established.

16. The method according to claim 15, wherein the media control relationships comprise binding relationships between Media Types and the Media-floor Control Entities.

17. The method according to claim 13, wherein the establishing of the corresponding media control relationship for the calling end according to the second media control policy comprises:
determining, by the server, whether the media control relationship to be negotiated about complies with the second media control policy;
establishing the corresponding media control relationship if the media control relationship to be negotiated about complies with the second media control policy;
otherwise, refusing to establish the corresponding media control relationship.

18. The method according to claim 13, wherein selecting a different second media control policy for use according to a different trigger condition comprises:
selecting a second media control policy according to a media type, and/or
selecting a second media control policy according to a caller, and/or
selecting a second media control policy according to other predefined policies.

19. A media session control server, comprising:
a media policy control element, adapted to determine a control policy for controlling media communication between a calling end and a called end according to a predefined control policy; and
a media control entity, adapted to receive a control policy transmitted from the media policy control element and to control the media communication between the calling end and the called end.

20. The server according to claim 19, wherein the media policy control element further comprises:
a media control policy storage element, which is connected with the media policy control element and adapted to store a control policy for controlling a media communication;
the media policy control element obtains a predefined control policy from the media control policy storage element.

21. The server according to claim 20, wherein the media policy control element comprises:
a first media policy control element, which stores a first media control policy and adapted to allocate the first media floor to the transmitting end.

22. The server according to claim 20, wherein the media policy control element further comprises:
a second media policy control element, adapted to establish a corresponding media control relationship for the calling end.

23. The server according to claim 20, wherein the media policy control element further comprises:
a media control policy maintenance terminal, adapted to maintain the media control policy.

24. The server according to claim 19, wherein the media control entity comprises:
a video&audio control entity, adapted to control a video&audio communication between the calling end and the called end; and/or
a speech control entity, adapted to control a speech communication between the calling end and the called end.

25. A media session control system, comprising a calling end, a server, and a called end, the server controlling a media communication between the calling end and the called end, where the server comprises:
a media policy control element, adapted to determine a control policy for controlling media communication between a calling end and a called end according to a predefined control policy; and
a media control entity, adapted to receive a control policy transmitted from the media policy control element and to control the media communication between the calling end and the called end.
